(19) United States
(12) Patent Application Publication
(10) Pub. No.: US 2013/0253672 A1
(43) Pub. Date: Sep. 26, 2013

(54) DEVELOPMENT SYSTEM AND METHOD FOR CREATING A CONTROL UNIT PROGRAM

(71) Applicant: dSPACE digital signal processing and control engineering GmbH, (US)

(72) Inventors: Mario ESCHMANN, Salzkotten (DE); Viktor NESTEROW, Paderborn (DE); Gernot DEUTENBERG, Bielefeld (DE)

(73) Assignee: dSPACE digital signal processing and control engineering GmbH, Paderborn (DE)

(21) Appl. No.: 13/847,630

(22) Filed: Mar. 20, 2013

(30) Foreign Application Priority Data
Mar. 20, 2012 (EP) EP12160249.4

(51) Int. Cl. G05B 15/02

(52) U.S. Cl. CPC G05B 15/02
USPC 700/83

(57) ABSTRACT

A development system for creating a control unit program, in which a control unit program is configured to control an electronic control unit in a vehicle. The development system includes an electronic computer unit, which is configured to generate the control unit program. The development system includes an input unit assigned to the electronic computer unit and a display unit assigned to the electronic computer unit. The display unit has a first display area and a second display area. At least one build process step can be executed by means of the development system.

This nonprovisional application claims priority under 35 U.S.C. §119(a) to European Patent Application No. EP 12160249.4, which was filed in Europe on Mar. 20, 2012, and which is herein incorporated by reference.

### BACKGROUND OF THE INVENTION

1. Field of the Invention

The invention relates to a development system and a method for creating a control unit program, in which the control unit program is designed to control an electronic control unit in a vehicle.

2. Description of the Background. Art

Development systems and methods for creating control unit programs are known in the conventional art. They usually serve a user as a development tool for creating, developing, testing, simulating, and/or calibrating control unit programs, for example, for a real control unit or a virtual electronic control unit (V-ECU) and/or a virtual processing unit (VPU).

A V-ECU is a virtual control unit, i.e., control unit software without direct hardware reference, which is integrated into a simulator, to simulate the behavior of a real electronic control unit. V-ECUs can be used as part of an offline or real-time simulation. V-ECUs use interfaces of the simulator backplane in order to communicate with other control units, plant models, or IO drivers. In the user's perception, the V-ECU often represents its entire ECU, including all IO-driver modules. In the technical sense, however, the V-ECU comprises only the part of the software above the backplane interface, because the deeper software layers are replaced by backplane modules of the specific simulator. During the runtime, the V-ECU with the aid of a VPU integration code is embedded in a frame (VPU) in order to create an executable simulator process therefrom.

A VPU is a virtual execution unit within the simulator, in which an application to be simulated is executed. A VPU has its own allocated virtual computing resources (core), virtual memory (RAM), and virtual timers. These resources are independent of other VPUs, so that the VPUs are simulated quasi-parallel. Likewise, the VPU has an independent set of OS resources (tasks, counters, alarms, events, critical sections, . . . ). The use of IO drivers and communication with other VPUs occurs via backplane services. In a real-time system, VPUs are generally executed on their own physical core. In an offline simulation, the allocation of the VPUs to cores occurs dynamically by the underlying operating system of the simulation environment (Windows).

An exemplary development system of the aforementioned type can be found in the product description for SystemDesk 3.1 (http://www.dspace.de/de/gmb/home/products/sw/system_architecture_software/system desk.cfm). SystemDesk is a tool for supporting the development of distributed electronic systems. SystemDesk is designed especially for creating control unit programs, which can be used in the so-called AUTOSAR standard (Automotive Open System Architecture).

Conventional development systems usually provide a user with a user interface for the development system, by means of which a model or architecture of the control unit program can be displayed graphically, for example, in the form of a tree structure with a number of software components, and edited. With the increasing complexity of current control unit programs and their models or architecture, the complexity of the development systems to be used for creating such control unit programs also increases. To this end, control unit programs must be modeled, for example, on multiple abstraction levels or in multiple layers. As a result, moreover, the number of graphical representations increases greatly, which are necessary for displaying individual software components or the architecture of the control unit program. In particular, during updating of an already available control unit program, for example, when individual software components in the architecture are to be replaced or updated, a simplified user interface is desirable.

### SUMMARY OF THE INVENTION

It is therefore the object of the invention to provide an improved development system and an improved method for creating a control unit program, particularly easy access for a user to a complex model of a control unit program.

In an embodiment, this object is attained by a development system having an electronic computer unit, which is designed to generate the control unit program, an input unit assigned to the electronic computer unit, and a display unit assigned to the electronic computer unit, whereby the display unit comprises: a first display area, in which the display unit graphically displays a build process of the control unit program in the form of a flowchart, whereby the flowchart comprises one or more successive build process steps in the build process, the steps which can be selected by means of the input unit, and a second display area, in which the display unit graphically displays at least elements of a model of the control unit program, the elements which are assigned to a selected build process step, whereby at least one build process step can be executed by the development system.

The term development system within the scope of the present invention can be understood to be a system by means of which a user, i.e., for example, a user of the development system, can develop, model, and create a control unit program. The created control unit program can then be used for simulation and/or for testing. The term control unit program within the scope of the present invention can be understood to be a measuring, control, regulation, and/or calibration program for controlling an electronic control unit in a vehicle. The term control unit program can cover both individual software components with different functions and complex software architectures with a plurality of interconnected software components. The term electronic control unit within the scope of the present invention can be understood to be a control system, for example, a control unit in a motor vehicle. The electronic control unit can be used in this case, for example, for measuring, controlling, regulating, and/or calibrating vehicle components. The term vehicle is used hereafter as a broad term for watercraft, land vehicles, aircraft, spacecraft, and/or combinations thereof.

The invention is based on the realization that the complexity of current control unit programs, but particularly also of the models of such control unit programs, is increasing steadily. In addition, a multitude of users are involved in the development and creation of a control unit program. Individual users often deal only with parts or components of the model or architecture of the control unit program. It is often the task of a user of a development system to edit, configure, update, and/or build a component of the architecture of the control unit program. For example, in the case of a multitude of individual users, it is at present time-consuming and difficult to allow a subtask to be performed by a single user. It is often necessary in this case that each individual user cognitively comprehends the entire architecture of the control unit program. This is time-consuming and costly user training is often necessary.

An advantage of the invention is that a user is provided with a simple to understand and easy access to the complex architecture of a control unit program in the form of a compact structuring comprehensible to the user. As a result, control unit programs of the aforementioned type can also be created, configured, and thereupon simulated and tested by user groups, familiar only to a limited extent with the processes and build steps necessary for this. Hence, the user is supported during the implementation of his tasks, particularly during the creation of a control unit program. At the same time, a user is provided with a combination of display, access, and intervention options for a sequence of build process steps.

An electronic computer unit within the scope of the present invention can be understood to be a component of a computer system, for example, a personal computer (PC) or workstation. The electronic computer unit in this case can, for example, execute a program, so that the computer system is configured as a development system for the creation of a control unit program. The input unit, assigned to the electronic computer unit, can be configured, for example, as a keyboard and/or mouse of the computer. The display unit, assigned to the electronic computer unit, can be configured, for example, as a computer monitor or screen. To this end, the input unit and the display unit can each be linked wirelessly or by means of a connecting cable, e.g., system bus, to the electronic computer unit.

The first display area of the display unit can be designed, for example, as a rectangular subregion of the entire display area of the display unit. In the display area, the build process of the control unit program can be shown graphically as a flowchart. The successive build process steps in the build process can be shown, for example, as block elements arranged one above another when seen from the viewing direction. In this regard, the first build process step in the build process can be shown at the very top. The build process steps following the first build process step can then be arranged graphically following one another in the downward direction, i.e., below the first build process step. Connecting lines or connecting arrows can be shown between the block elements to make the order of the build process steps clear to the user.

The second display area of the display unit can also be shown as a rectangular subregion of the entire display area of the display unit. Elements of the model or the architecture of the control unit program are shown graphically in the display area. These elements can be displayed graphically in different ways, for example, by category or type of element in different form, color, brightness, and/or with a different texture. The build process steps can be selected, for example, by means of the input unit, which has the result that elements, assigned to the selected build process step, of the model of the control unit program are displayed in the second display area.

A user can select and moreover execute one or more build process steps by means of the input unit. As a consequence, for example, elements of the model of the control unit program can be created or updated.

The display areas can be arranged next to one another when seen in the view direction. For example, the first display area can be displayed on the left next to the second display area. In the case of rectangular display areas, therefore a rectangular overall view of two display areas arranged next to one another can be created. As a result, a user is given a clear orientation with respect to the flow of a build process. In the first display area (on left), the build process can be shown, for example, as a string of blocks, each of which represent a build process step. The orientation and selective access to relevant partial information or subfunctions are made possible for the user by this display.

If a build process step is selected, for example, in the form of a block in the flowchart, the elements of the model of the control unit program, which are elements assigned to the selected build process step, are shown in the second display area. These can be elements that are modified, edited, or updated during the build process step or are used as configuration parameters. The term elements of a model of the control unit program within the scope of the present invention can therefore be understood as follows: Before the control unit program is created, it is available in the development system in the form of a model. This model contains a number of different components (elements) such as, for example, software components, configuration parameters, etc. During the creation, the control unit program is generated from elements of the model or with consideration of these.

The assignment of the elements to a build process step is established, for example, during the definition and customization of the build process step. The elements can be shown either individually or as groups of similar elements in a folder. The elements can be shown in a hierarchical architecture as a parent element with a number of child elements.

According to an embodiment of the development system of the invention, an element, particularly a selected element, which is assigned to a build process step, is modified, particularly updated, during the execution of the build process step. The user is thus given a filter functionality by selecting an element. The selection can be made, for example, in that the user, by means of the input unit, places a graphic checkmark in a box assigned to one of the elements. Selection of an element by the user and execution of a build process step, to which the element is assigned, leads to the result that only the selected element is modified or updated during the build process step. In addition to the filter functionality it becomes also possible that subtasks of a complex and time-consuming build process can be executed efficiently in that only the selected elements of a build process step are modified or updated during the execution of this build process step. As a result, the overall computing power can be economized during the creation of a control unit program.

According to another embodiment of the development system of the invention, a selected build process step is visually highlighted, particularly for visual differentiation from a non-selected build process step. The visual highlighting of a selected build process step can occur in that the build process step is shown in a color, contrast, and/or with a texture that are different from the color, contrast, and/or texture of the non-selected build process steps. In addition, the visual highlighting of a selected build process step can occur by animation of the selected build process step; i.e., the color, contrast, and/or texture of the selected build process step vary over time.

Furthermore, a completed or ended execution of a build process step can be displayed graphically, so that the user is informed of the result of the execution of the build process step.

In another embodiment of the development system of the invention, an element is selectable, whereby the selected element is visually highlighted, particularly for differentiation from a non-selected element. As a result, this enables the user to obtain rapidly and simply, even upon a cursory viewing of the second display area, an overview of the selected elements. The visual highlighting of an element can occur similar to the visual highlighting of a build process step, particularly by a changed contrast, a changed color, and/or a changed texture in comparison with the non-selected elements.

Like the visual highlighting of an executed build process step, the modifying or updating of an element can be highlighted visually; for example, by animation.

According to another embodiment of a development system of the invention, the element comprises an application software component and/or a basic software module and/or a VPU.

The term application software component within the scope of the present invention can be understood to be a software component that defines a defined functionality at the application level and runs an AUTOSAR infrastructure. In this regard, the term software component (SW-C) can be understood to be an element of the model or architecture, the element which provides and/or requires interfaces to other software components and is connected to other software components via these interfaces. The term software module within the scope of the present invention can be understood to be a collection of software files, i.e., source code and description, which provide a specific software functionality in an electronic control unit. The term basic software module within the scope of the present invention can be understood as a collection of software files, which provide a specific basic software functionality in an electronic control unit.

According to another embodiment of a development system of the invention, a build process step is assigned a context menu with one or more selectable options for editing the build process step, whereby the context menu is displayed visually by the display unit. The user is given various options for editing a build process step by means of the context menu. For example, an option for executing the build process step can be shown by means of the context menu. Furthermore, a selectable option for editing the build process step can be shown by means of the context menu.

According to another embodiment of a development system of the invention, an element is assigned a context menu with one or more selectable options for editing the element, whereby the context menu is displayed visually by the display unit. The context menu can provide the user with a number of selectable options, for example, for editing, selecting, and/or proofing the element.

According to a further embodiment of the development system of the invention, a single build process step can be executed. As a result, for example, a single build process step can be selected and executed, without other build process steps following the selected build process step in the build process sequence being executed. This embodiment provides a filter functionality, allowing especially the performance of subtasks efficiently and in a time-saving manner within the overall build process of the control unit program. The term build process sequence within the scope of the present invention can be understood especially as the order of build process steps in the build process.

According to another embodiment of the development system of the invention, an element can be edited particularly by means of the input unit. For example, the user can call up an option for editing the element by means of the context menu. In this case, the user can be provided with and shown an editing environment, for example, an editor, by which the element can be edited.

According to another embodiment of a development system according to the invention, the system has a selectable first execute element, particularly a first execute box displayed visually by the display unit, whereby selection of the first execute element causes a selected build process step to be executed. The execute element can be displayed graphically in the form of an execute box, for example, in the first display area. In this regard, the input unit, for example, a computer mouse, can be used to select the execute element, as a result of which a selected build process step is executed.

According to another embodiment of the development system according to the invention, a plurality of successive build process steps in the build process sequence can be executed. The execution of several build process steps, for example, can occur automatically by selecting a corresponding execute element. This enables the user to carry out a plurality of build process steps, without an execution of a single build process step having to be initiated repeatedly by selection of a corresponding execute element.

According to another embodiment of the development system of the invention, the system has a selectable second execute element, particularly a second execute box displayed visually by the display unit, whereby selection of the second execute element causes the selected build process step and at least one build process step preceding the selected build process step in the build process sequence to be executed or the selected build process step and at least one build process step following the selected build process step in the build process sequence to be executed. As a result, two especially advantageous alternatives of a filter functionality are achieved during the execution of one or more build process steps. In the first alternative, with the selection of the second execute element, all those build process steps preceding the selected build process step in the build process sequence are executed. In this case a user can select, for example, first a build process step and then select the second execute element, so that a plurality of build process steps are executed, namely, the build process steps preceding the selected build process step in the build process sequence and the selected build process step. In the second alternative, by selecting the second execute box, first the selected build process step and subsequently the build process steps are executed that follow the selected build process step in the build process sequence. A user can select to this end first a build process step and thereupon select the second execute box, which has the effect that the selected build process step and all build process steps following in the build process sequence are executed. As a result, especially expedient alternatives for executing a subsection of the build process are provided for executing the subtasks. At the same time, both indicated alternatives are especially simple to execute for the user.

According to another embodiment of the development system of the invention, a build process step is visually highlighted during execution, particularly for visual differentiation from a non-executed build process step. In other words, a build process step is highlighted visually during the execution for differentiation from non-executed build process steps, for example, by animation of the executed build process step. The visual highlighting shows the user whether a build process step is currently being executed or whether execution of a build process step has already been completed. The visual highlighting of the executed build process step can occur, for example, by means of animation. Furthermore, the visual highlighting of the build process step can occur in that the build process step in the first display area has a color, contrast, and/or texture that differ from the color, contrast, and/or texture of the non-executed build process steps.

The aforementioned object is attained, moreover, by a method for creating a control unit program of the aforementioned type. The method includes the steps: graphically displaying a build process of an electronic control unit program, whereby the build process is graphically displayed in the form of a flowchart in a first subregion of a display unit, whereby the flowchart comprises one or more successive build process steps in the build process, the steps that are selectable by means of an input unit; selecting a graphically displayed build process step; graphically displaying at least one element of a model of the control unit program, which is assigned to the selected build process step, in a second subregion of the display unit; and executing at least one build process step.

An embodiment of the method of the invention includes the step: updating a selected element, assigned to a build process step, during the execution of the build process step.

Another embodiment of the method of the invention includes the step: visually highlighting a selected build process step, particularly for visual differentiation from a non-selected build process step.

Another embodiment of the method of the invention includes the steps: selecting an element, particularly by means of the input unit, and visually highlighting a selected element, particularly for visual differentiation from a non-selected element.

Another embodiment of the method of the invention includes the step: executing a single selected build process step.

According to another embodiment of the method of the invention, the execution occurs by selection of a first execute element, particularly a first execute box displayed graphically by the display unit.

Another embodiment of the method of the invention includes a step executing a number of successive build process steps in the build process sequence, whereby a selected build process step and at least one build process step preceding the selected build process step in the build process sequence is executed or whereby a selected build process step and at least one build process step following the selected build process step in the build process sequence is executed.

The method of the invention and its embodiments have features or process steps that make them especially suitable to be used for a development system of the invention and the embodiments thereof. In regard to advantages, execution variants, and execution details of this method and method refinements, reference is made to the previous description of the corresponding system features.

The aforementioned object is attained, moreover, by a computer program with a program code stored on a computer-readable data medium, and the development system according to one of the previously described exemplary embodiments for executing the steps of the method according to one of the previously described embodiments, when this program code of the computer unit are executed by the development system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given herein below and the accompanying drawings which are given by way of illustration only, and thus, are not limitive of the present invention, and wherein:

FIG. 1 shows a first configuration of an exemplary embodiment of a development system of the invention;

FIG. 2 shows a second configuration of the exemplary embodiment, shown in FIG. 1, of a development system of the invention;

FIG. 3 shows a third configuration of the exemplary embodiment of a development system according to the invention, as shown in FIGS. 1 and 2;

FIG. 4 shows a fourth configuration of the exemplary embodiment of a development system according to the invention, as shown in FIGS. 1 to 3;

FIG. 5 shows a schematic flowchart of a method of the invention; and

FIG. 6 shows a block diagram of components of a computer system.

### DETAILED DESCRIPTION

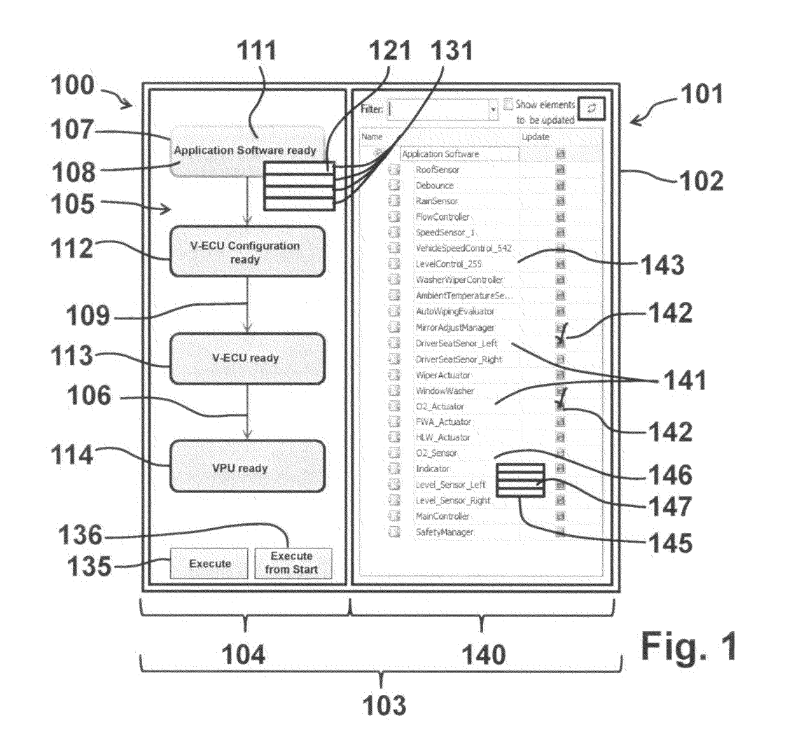

FIGS. 1 through 4 each show configurations 100, 200, 300, 400 of an exemplary embodiment of development system 101 of the invention. In particular, FIG. 1 shows a subregion 103 of a display unit 102. Subregion 103 of display unit 102 shows a first display area 104, which represents a left rectangular area of subregion 103. In first display area 104, display unit 102 graphically displays a build process 105 of a control unit program in the form of a flowchart 106. Flowchart 106 has a number of blocks 107, which are arranged one above the other when seen in the view direction and each of which represents a build process step 108. In the build process, the individual build process steps 108 follow one another. This is shown graphically by display unit 102 by means of connecting lines or connecting arrows 109, which connect blocks 107 to one another.

The individual build process steps 108 can be selected by means of an input unit. In the configuration shown in FIG. 1, build process step 111, shown at the very top, “Application Software Ready” is visually highlighted, i.e., for visual differentiation from the non-selected build process steps 112, 113, 114. Build process step 111 in this case is visually highlighted in that the border line of block 107 is shown brighter than the border lines of the other blocks of build process steps 112, 113, 114.

Build process step 111 is assigned a context menu 121, which can be called up by the input unit. Context menu 121 shows a number of selectable options 131 for editing build process step 111.

A selectable first execute box 135, which is provided as the selectable first execute element, can be selected by means of the input unit. When execute box 135 is selected, for example, by a mouse click or actuation of a key provided for this purpose, the selected build process step 111 is executed. In other words, all actions within a build process belonging to this build process step 111 are executed. A selectable second execute box 136, which is provided as a selectable second execute element, can be selected like the first execute box 135 by means of the input unit. If the second execute box 136 is selected, the selected build process step and all build process steps preceding the selected build process step in the build process sequence are executed. If, for example, build process step 113 is selected, upon selection of second execute box 136, first build process step 111, then build process step 112, and finally the selected build process step 113 are executed.

Display unit 102 graphically shows a number of elements 141 of a model of a control unit program in a second display area 140. Second display area 140 is shown in the form of a rectangular display area of subregion 103. Elements 141 are elements that are assigned to a selected build process step 111 shown in first display area 104. In other words, when build process step 111 shown in first display area 104 is selected, elements 141 of a model of the control unit program that are to be edited during the execution of a build process step or are involved in it, i.e., are assigned to the build process step, are displayed graphically in second display area 140.

Display unit 102 in second display area 140 shows a number of boxes 142, each of which is assigned to one element 141. A box 142 can be selected in each case by means of the input unit; i.e., for example, a check is placed in the box, as a result of which element 141, assigned to box 142, can be selected. As a result, selected element 141 is visually highlighted for differentiation from non-selected element 143. Development system 101 of the invention is designed in such a way that during execution of a build process step 111 only selected elements 141 are modified or updated. The execution of a build process step 111, moreover, can be shown visually, for example, by animation of build process step 111, for differentiation from non-executed build process steps 112, 113, 114.

A context menu 145, which is assigned, for example, to an element 146 “O2_Actuator,” can be called up by means of the input unit. Context menu 145 shows a number of selectable options for editing element 146. For example, context menu 145 can show an option 147 for editing element 146. If this option 147 is selected by means of the input unit, for example, an editor can be opened, which is designed for editing element 146.

FIG. 1 shows in particular a build process in which a control unit program is created. The control unit program is designed to control an electronic control unit in a vehicle. In this regard, the control unit program is designed in such a way that it can be used as part of the so-called AUTOSAR standard. The configuration shown in FIG. 1 shows a build process 105, in which the selected build process step 111 is designated as “Application Software ready.” If this build process step 111 is selected, software components that are used during build process step 111 are shown in second display area 140. Moreover, the properties of a software component can be called up via context menu 145, i.e., for example, the source path of the source files representing the software components. In addition, for example, the properties of a number of selected software components can be called up simultaneously.

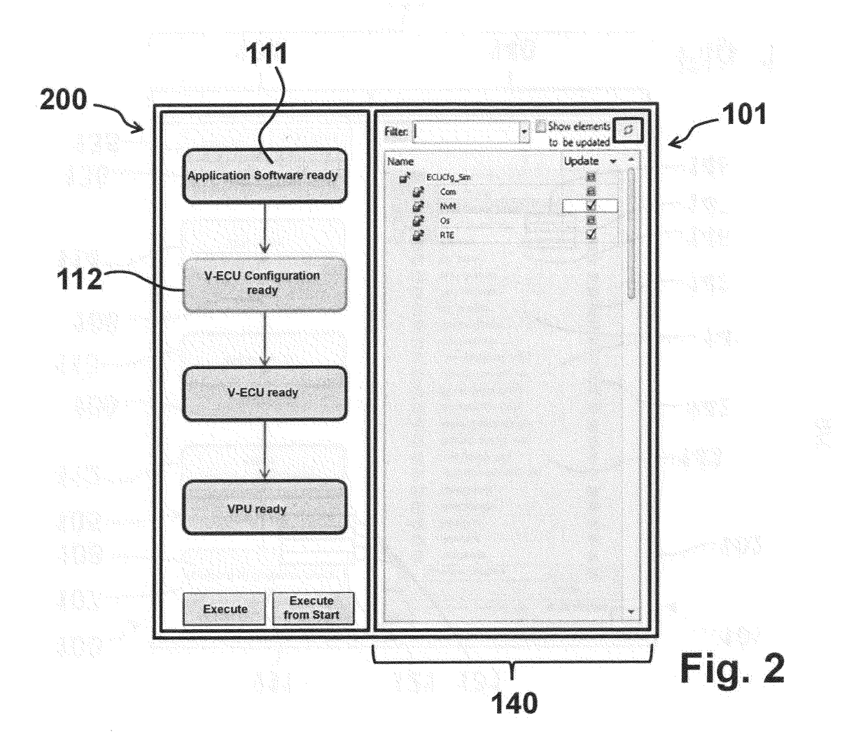

FIG. 2 shows the exemplary embodiment, shown in FIG. 1 and described above, of development system 101 of the invention in a second configuration 200. In this configuration 200, build process step 112 with the designation “V-ECU Configuration ready” is selected. The configuration of the control unit program with the assigned basic software modules is indicated in second display area 140. During execution of build process step 112, the basic software modules are created for further use; i.e., configurations can be created in build process step 112 for each existing basic software module. The basic software modules, shown by way of example in second display area 140, are Communication (COM), Operating System (OS), Runtime Environment (RTE), and NVRAM Manager (NvM; NVRAM: Non-Volatile Random-Access Memory). The RTE makes available a runtime environment by means of which a standardized communication layer is provided for different functions among one another. The NvM makes available services to assure data storage and the maintenance of non-volatile data according to their individual specifications in a vehicle environment (also see AUTOSAR Specification of NVRAM Manager V3.1.0 R4.0 Rev2).

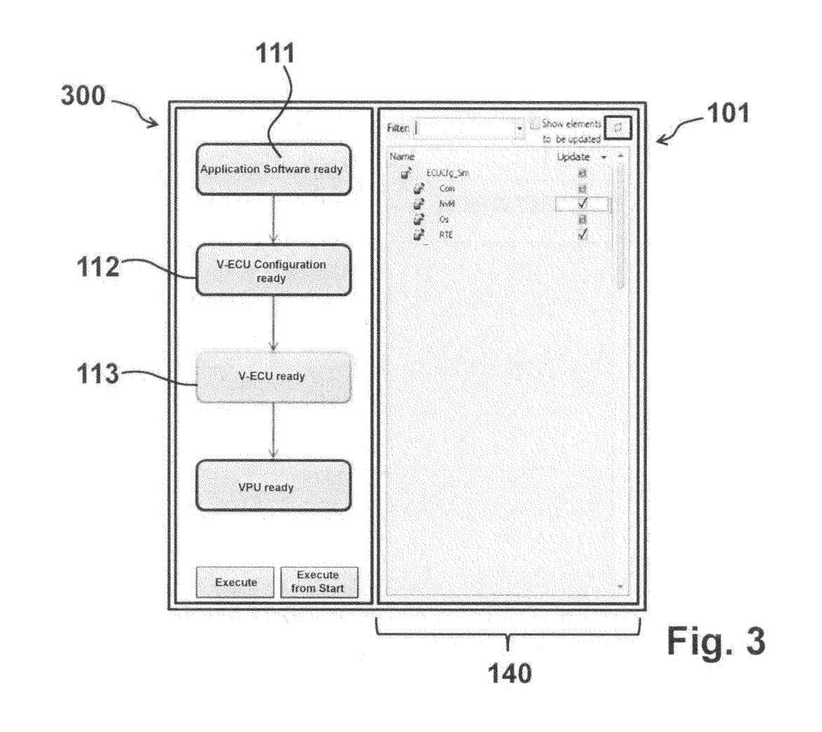

FIG. 3 shows the exemplary embodiment, shown in FIG. 1 and described above, of a development system 101 of the invention in a third configuration 300. In this third configuration 300, build process step 113 with the designation ‘V-ECU ready” is selected. When this build process step 113 is selected, a configuration of the control unit program with the assigned basic software modules is shown in the second display area 140 similar to the presentation of the elements in the above-described build process step 112. During the execution of build process step 113, final work on the basic software modules is performed. For example, a runtime environment (RTE) is generated and then an implementation of a control unit program is created.

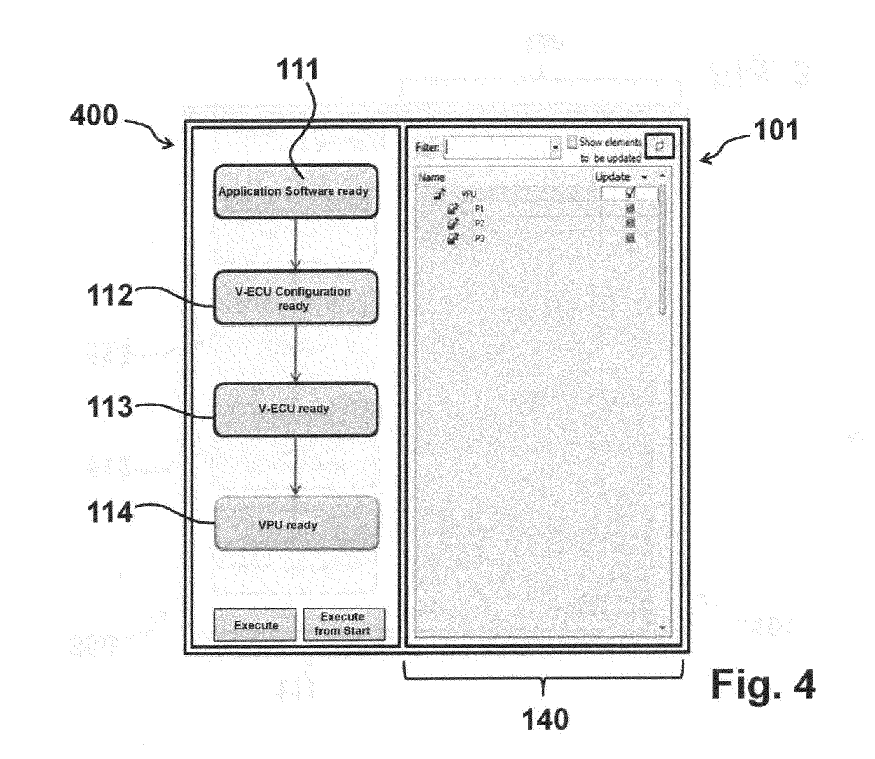

FIG. 4 shows the exemplary embodiment, shown in FIGS. 1 to 3, of a development system of the invention in a configuration 400. In this configuration 400, build process step 114 with the designation “VPU ready” is selected. In the second display area 114, the configuration of a virtual processing unit (VPU) with the assigned ports is indicated. During the execution of build process step 114, on the one hand, the VPU is configured and then built. In other words, the VPU is generated, for example, for later simulation from a created V-ECU configuration (FIG. 2) and after the already completed generation of the basic software modules (FIG. 3) in build process step 114 shown in FIG. 4.

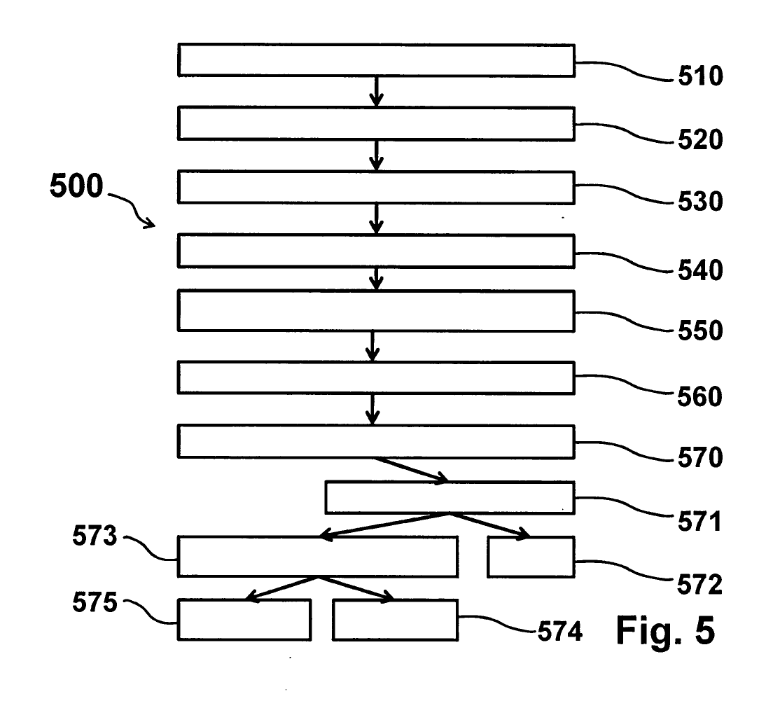

FIG. 5 shows an exemplary embodiment of a method 500 of the invention. In this regard, method 500 is shown schematically as a flowchart. The method is described with reference to development system 101, shown in FIGS. 1 to 4, for executing the method 500 of the invention. The steps illustrated in FIG. 5 and described hereafter need not be performed in this order but can also occur in a different order. In particular, steps can be continued, interrupted, resumed, or repeated while other steps are added.

In a step 510, a build process, shown in FIG. 1, of a control unit program is shown graphically. The displaying in this case occurs in the form of a flowchart, as shown in FIG. 1, in first subregion 104 of display unit 102. The flowchart comprises one or more successive build process steps 111, 112, 113, 114 in the build process sequence, the steps that can be selected by means of an input unit.

In another process step 520, a build process step 111, shown graphically in FIG. 1, is selected, for example, by a user by means of an input unit. In a process step 530, the selected build process step 111 is then visually highlighted, particularly for visual differentiation from a non-selected build process step.

In another process step 540, after the selection of a build process step 111 at least one element 141 of a model of the control unit program, the element which is assigned to the selected build process step 111, is displayed graphically in a second subregion 140 of display unit 102.

In another process step 550, an element 141 can be selected, for example, by means of the input unit, so that selected element 141 is visually highlighted for visual differentiation from a non-selected element 143 in a process step 560.

In another process step 570, at least one build process step 111, shown in FIG. 1, can be executed. The execution 570 occurs in this case, for example, by selection 571 of a first execute box 135, displayed graphically by display unit 102 and provided as the first execute element. In another process step 572, in this case, a single selected build process step 111 can be executed, for example, by selection of first execute box 135. In another alternative process step 573, a number of successive build process steps in the build process sequence can be executed, for example, by selection of a second execute box 136. In this case, a selected build process step and at least one build process step preceding the selected build process step in the build process sequence can be executed in a process step 574. Alternatively, a selected build process step and at least one build process step following the selected build process step in the build process sequence can be executed in a process step 575.

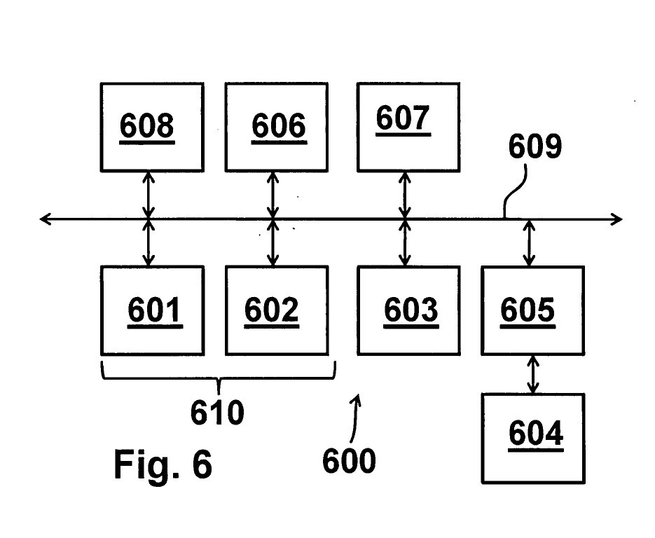

FIG. 6 shows a computer system 600 (e.g., a computer client, server computer, etc.) comprising a plurality of components for providing the above-described development system of the invention. Components such as, for example, a mouse 601, a keyboard 602, a hard drive 603 (or another memory with a computer-readable data medium), a display unit 604, which is linked by means of a display connection unit 605 to the other components, a central computer unit 606 (CPU), a system memory 607, and an input/output unit 608 (I/O unit) are shown in FIG. 6. The connections 609 shown by means of connecting arrows in the form of a system bus enable central computer unit 606 to communicate with each component and to control the execution of instructions from a system memory 607 or hard drive 603 and the exchange of information between the components. System memory 607 and/or hard drive 603 can be provided as computer-readable data storage media. The input/output unit 608 can be configured to enable communication of computer system 600 with other computer systems, network components, or control devices. Mouse 601 and keyboard 602 form an input unit 610 for a user by means of which, for example, elements displayed graphically on display unit 604 can be selected, edited, etc. Input unit 610 can also be used to execute or start an instruction of a program code, stored in system memory 607 and/or hard drive 603, in the computer system.

Any software components or functions described in this application, can be implemented as software code, which can be executed by a processor, with use of any computer language such as, for example, C, Java, C++, or Pearl and using, for example, conventional or object-oriented methods. The software code can be stored as a series of instructions or commands on a computer-readable data medium such as, for example, a random access memory (RAM), or read only memory (ROM), a magnetic medium such as, for example, a hard drive, or an optical medium such as, for example, a CD-ROM.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A development system for creating a control unit program, the control unit program being configured to control an electronic control unit in a vehicle, the system comprising:
an electronic computer unit configured to generate the control unit program;
an input unit assigned to the electronic computer unit; and
a display unit assigned to the electronic computer unit, the display unit comprising:
a first display area, in which the display unit graphically displays a build process of the control unit program in the form of a flowchart, the flowchart comprising one or more successive build process steps in the build process, the one or more successive build process steps being selectable via the input unit; and
a second display area, in which the display unit graphically displays at least one element of a model of the control unit program, the element being assigned to the selected build process step,
wherein at least one build process step is executable by the development system.

2. The development system according to claim 1, wherein an element or a selected element that is assigned to a build process step, is modified and/or updated during an execution of the build process step.

3. The development system according to claim 1, wherein a selected build process step is visually highlighted for visual differentiation from a non-selected build process step.

4. The development system according to claim 1, wherein an element is selected and the selected element is visually highlighted to differentiate such from a non-selected element.

5. The development system according to claim 1, wherein the element comprises an application software component and/or a basic software module and/or VPU.

6. The development system according to claim 1, wherein a build process step is assigned a context menu with one or more selectable options for editing the build process step, and wherein the context menu is configured to be displayed visually by the display unit.

7. The development system according to claim 1, wherein an element is assigned a context menu with one or more selectable options for editing the element, and wherein the context menu is displayed visually by the display unit.

8. The development system according to claim 1, wherein an element is adapted to be edited by the input unit.

9. The development system according to claim 1, wherein a single build process step is configured to be executed.

10. The development system according to claim 9, further comprising a selectable first execute element or a first execute box displayed visually by the display unit, wherein selection of the first execute element causes a selected build process step to be executed.

11. The development system according to claim 1, wherein a plurality of successive build process steps in the build process sequence are executable.

12. The development system according to claim 11, further comprising:
a selectable second execute element or a second execute box displayed visually by the display unit, wherein selection of the second execute element causes:
the selected build process step and at least one build process step, which precedes the selected build process step in the build process sequence, to be executed; or
the selected build process step and at least one build process step, which follows the selected build process step in the build process sequence, to be executed.

13. The development system according to claim 1, wherein a build process step is visually highlighted during execution for visual differentiation from a non-executed build process step.

14. A method for creating a control unit program, the control unit program being configured to control an electronic control unit in a vehicle, the method comprising:
graphically displaying a build process of a control unit program, the build process being graphically displayed as a flowchart in a first subregion of a display unit, the flowchart comprising one or more successive build process steps in the build process, the build process steps being selectable via an input unit;
selecting a graphically displayed build process step;
graphically displaying at least one element of a model of the control unit program, which is assigned to the selected build process step in a second subregion of the display unit; and
executing at least one build process step.

15. The method according to claim 14, further comprising: updating a selected element that is assigned to a build process step during the execution of the build process step.

16. The method according to claim 14, further comprising: visually highlighting a selected build process step for visual differentiation from a non-selected build process step.

17. The method according to claim 14, further comprising:
selecting an element via the input unit; and
visual highlighting a selected element for the visual differentiation from a non-selected element.

18. The method according to claim 14, further comprising: executing a single selected build process step.

19. The method according to claim 18, wherein the execution occurs by selection of a first execute element or a first execute box displayed graphically by the display unit.

20. The method according to claim 14, further comprising:
executing a plurality of successive build process steps in the build process sequence,
wherein a selected build process step and at least one build process step preceding the selected build process step in the build process sequence is executed, or
wherein a selected build process step and at least one build process step following the selected build process step in the build process sequence is executed.
